(19) United States
(12) Patent Application Publication
(10) Pub. No.: US 2023/0015054 A1
(43) Pub. Date: Jan. 19, 2023

(54) TEXT CLASSIFICATION METHOD, ELECTRONIC DEVICE AND COMPUTER-READABLE STORAGE MEDIUM

(71) Applicant: Aishu Technology Corp., Minhang District, Shanghai (CN)

(72) Inventors: Ares Zhang, Minhang District, Shanghai (CN); Maxwell MA, Minhang District, Shanghai (CN)

(21) Appl. No.: 17/638,167

(22) PCT Filed: Aug. 12, 2020
(86) PCT No.: PCT/CN2020/108652

§ 371 Date: Oct. 7, 2022

(30) Foreign Application Priority Data
Sep. 11, 2019 (CN) 201910859082.8

(51) Int. Cl. G06F 40/279; G06N 3/08

(52) U.S. Cl. CPC G06F 40/279; G06N 3/08; G06Q 50/265

(57) ABSTRACT

Provided are a text classification method, an electronic device, and a computer-readable storage medium. The method includes acquiring the to-be-tested text; detecting a sensitive word through an AC automaton to determine whether the to-be-tested text contains the sensitive word; and in response to a determination result that the to-be-tested text contains the sensitive word, determining the text category of the to-be-tested text based on the sensitive word contained in the to-be-tested text.

The present disclosure claims priority to Chinese Patent Application No. 201910859082.8 filed with the China National Intellectual Property Administration (CNIPA) on Sep. 11, 2019, the disclosure of which is incorporated herein by reference in its entirety.

### TECHNICAL FIELD

The present application relates to the technical field of text analysis, for example, a text classification method, an electronic device, and a computer-readable storage medium.

### BACKGROUND

In the field of text analysis, text classification is always a focus of researches, among which a relatively great number of researches are conducted on the classification of common text (for example, common text in categories such as finance and economics, entertainment, and sports), but a relatively small number of researches are conducted on the classification of illegal or politically sensitive articles. The field of text classification is flooded with traditional classification methods and learning algorithms of classification methods, for example, <HHH> vector machine (SVM), k-nearest neighbor algorithm (KNN), and random forests, as well as neural network classification methods that are popular in recent years. In the related technology, a model is established using an algorithm based on text-feature words to classify text. However, the related technology can provide merely a probability value regarding the text and cannot determine the category of an article based on a certain word.

### SUMMARY

The present application provides a text classification method, an electronic device, and a computer-readable storage medium to overcome the deficiencies existing in the preceding related technology.

The present application provides a text classification method. The method includes the steps below.
In step 1, the to-be-tested text is acquired, and then steps 2 and 3 are performed simultaneously.
In step 2, a sensitive word is detected through an Aho-Corasick (AC) automaton, and then step 4 is performed.
In step 3, illegal content is identified through a recurrent neural network model, and then step 6 is performed.
In step 4, it is determined whether the to-be-tested text contains the sensitive word; and step 5 is performed in response to a determination result that the to-be-tested text contains the sensitive word, or step 3 is returned to in response to a determination result that the to-be-tested text does not contain the sensitive word.
In step 5, in response to the to-be-tested text containing the sensitive word, the text category is determined based on the sensitive word, and then step 9 is performed.
In step 6, it is determined whether the to-be-tested text contains the illegal content; and step 7 is performed in response to a determination result that the to-be-tested text contains the illegal content, or step 8 is performed in response to a determination result that the to-be-tested text does not contain the illegal content.
In step 7, in response to the to-be-tested text containing the illegal content, the text category is determined based on the illegal content, and then step 9 is performed.
In step 8, in response to the to-be-tested text not containing the illegal content, step 9 is performed.
In step 9, the current round of processing logic is ended.

The present application further provides a text classification method. The method includes the steps below.
A to-be-tested text is acquired.
A sensitive word is detected through an AC automaton to determine whether the to-be-tested text contains the sensitive word.

In response to a determination result that the to-be-tested text contains the sensitive word, the text category of the to-be-tested text is determined based on the sensitive word contained in the to-be-tested text.

The present application further provides an electronic device including a processor and a memory.

The memory is configured to store a program.

When the program is executed by the processor, the processor implements any preceding text classification method.

The present application further provides a computer-readable storage medium storing computer-executable instructions for executing any preceding text classification method.

### BRIEF DESCRIPTION OF DRAWINGS

FIG. 1 is a flowchart of the present application.

FIG. 2 is a diagram illustrating the structure of a trie according to embodiments of the present application.

FIG. 3 is a diagram illustrating the structure of the trie and fail pointers according to embodiments of the present application.

FIG. 4 is a diagram illustrating the structure of a matching path according to embodiments of the present application.

FIG. 5 is a flowchart of identification of illegal content through a recurrent neural network according to the present application.

FIG. 6 is a diagram illustrating the structure of an electronic device according to embodiments of the present application.

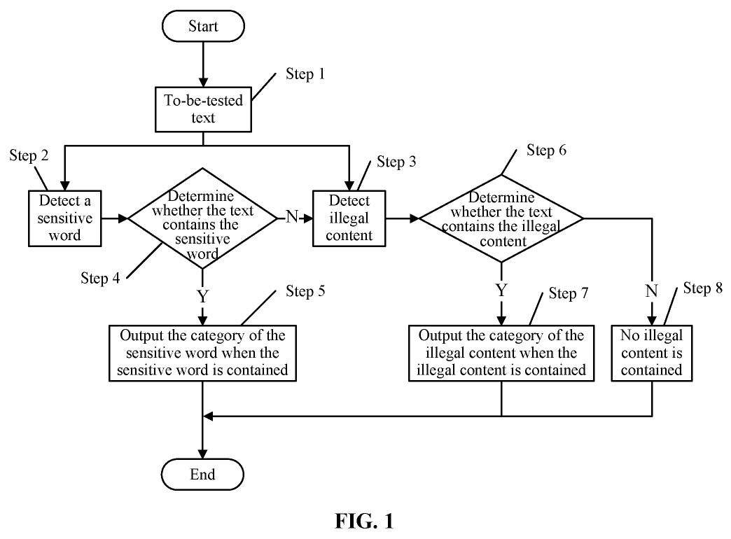

### DETAILED DESCRIPTION

The technical solutions in the embodiments of the present application are described hereinafter clearly and completely in connection with the drawings in the embodiments of the present applications. Apparently, the described embodiments are part, not all, of embodiments of the present application.

A text classification method is provided. The method includes the steps below.
In step 1, the to-be-tested text is acquired, and then steps 2 and 3 are performed simultaneously.
In step 2, a sensitive word is detected through an Aho-Corasick (AC) automaton, and then step 4 is performed.
In step 3, illegal content is identified through a recurrent neural network model, and then step 6 is performed.
In step 4, it is determined whether the to-be-tested text contains the sensitive word; and step 5 is performed in response to a determination result that the to-be-tested text contains the sensitive word, or step 3 is returned to in response to a determination result that the to-be-tested text does not contain the sensitive word.
In step 5, in response to the to-be-tested text containing the sensitive word, the text category is determined based on the sensitive word, and then step 9 is performed;
In step 6, it is determined whether the to-be-tested text contains the illegal content; and step 7 is performed in response to a determination result that the to-be-tested text contains the illegal content, or step 8 is performed in response to a determination result that the to-be-tested text does not contain the illegal content.
In step 7, in response to the to-be-tested text containing the illegal content, the text category is determined based on the illegal content, and then step 9 is performed.
In step 8, in response to the to-be-tested text not containing the illegal content, step 9 is performed.
In step 9, the current round of processing logic is ended.

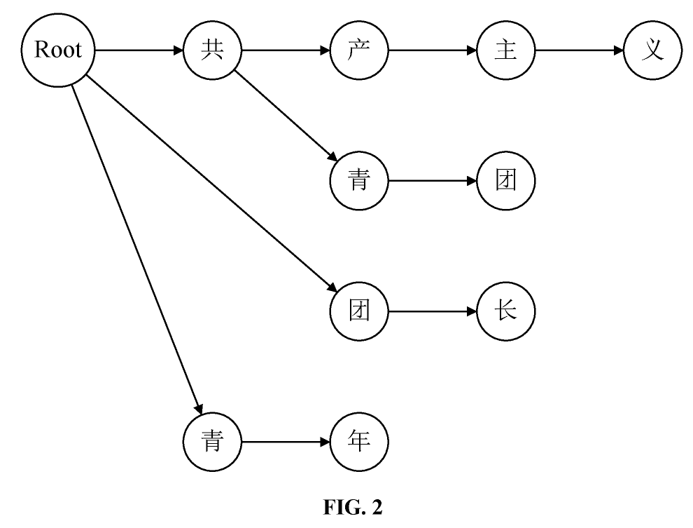

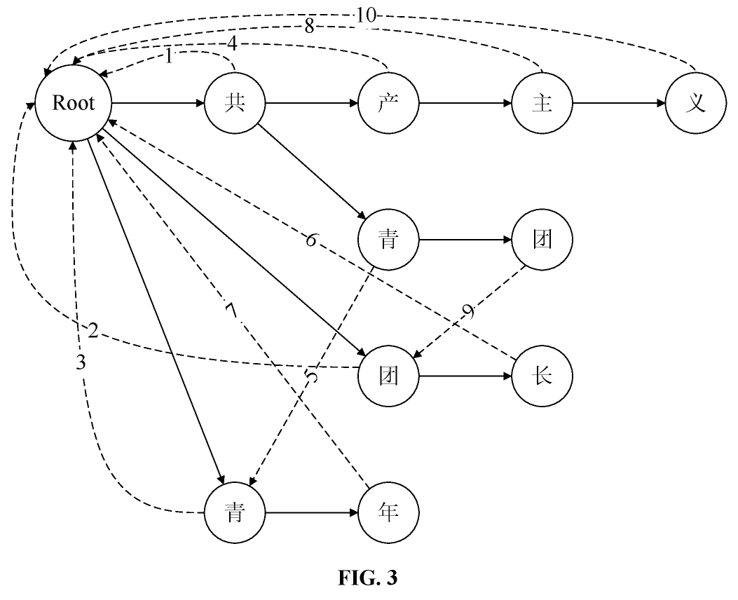

When a sensitive word is detected through the AC automaton in step 2, first a trie is created by using a sensitive-word dictionary. In this embodiment, the trie is created with an example in which a dictionary includes multiple words [ [symbol] ]. As shown in FIG. 2, the greatest function of the trie is to store the words in the dictionary except that these words are expressed in the form of a tree. As shown in FIG. 3, then fail pointers are added on the basis of the trie.

The sensitive-word dictionary may be created by customization. Alternatively, a built-in dictionary may be used as the sensitive-word dictionary.

### Embodiment One

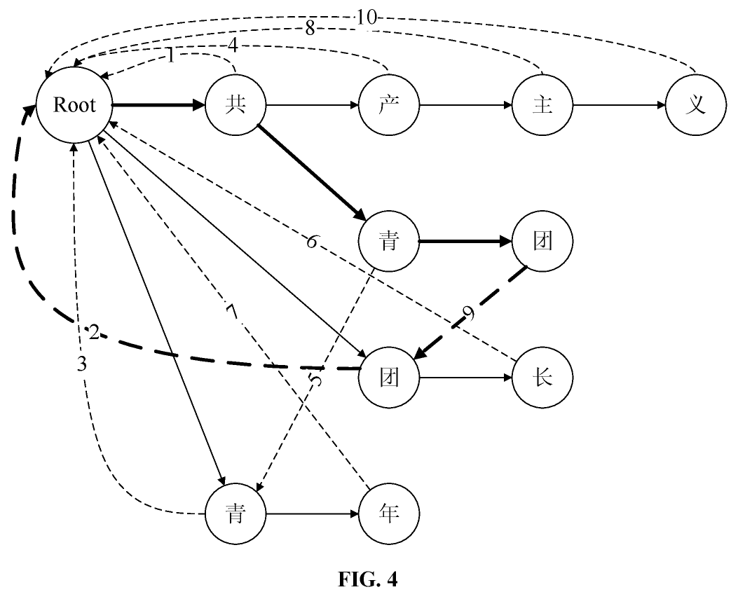

When a Chinese character string, for example " [symbol] " is input, " [symbol] " serves as a match. The matching path is shown in FIG. 4, and the matching process may be as follows: With only node " [symbol] ", node " [symbol] ", and node " [symbol] " being child nodes of the root node, the character string " [symbol] " is input by traversing; the first four characters " [symbol] ", " [symbol] ", " [symbol] ' and " [symbol] " do not match any node; " [symbol] " in the character string matches node " [symbol] "; since node " [symbol] " and node " [symbol] " are the next nodes of node " [symbol] ", " [symbol] " in the character string matches node " [symbol] "; since node " [symbol] " is the next node of node " [symbol] ", " [symbol] " in the character string matches node " [symbol] ", and then the maximum length of this path is reached; since being contained in the dictionary, " [symbol] " serves as a match; then the position of the failure link of node " [symbol] " is skipped to; however, since the character after " [symbol] " in the character string " [symbol] " is " [symbol] ", the failure link of node " [symbol] " points to the root node; and finally " [symbol] " serves as a match.

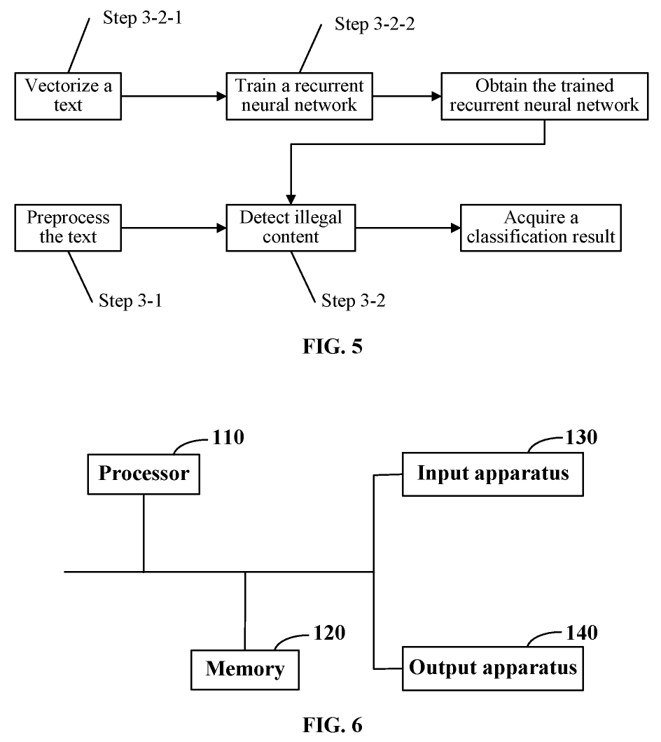

Detection of illegal content through a recurrent neural network in step 3 mainly includes two parts. As shown in FIG. 5, one part is model training, and the other part is detection of illegal content by using the trained model.

A dictionary and the tagged training data can be used for the training of the model. The dictionary may include as many words as possible. The dictionary may include some illegal words and may also include some normal words. A tag carried by the training data needs to be accurate. The training data may be tagged artificially to guarantee accuracy. In modeling training, a word frequency vector of a word belonging to a lexicon, contained in an article in the training data and found through the dictionary is used as an input vector for performing training.

### Embodiment Two

### Training Parameters

Dictionary: {illegal, politically, reactionary, prohibited, legal}

Training text: "Some website is an illegal website containing politically reactionary content. The access to the website is prohibited in China."

### Training Preprocessing

Text tag: [0, 1, 0, 0] ([1, 0, 0, 0] denotes normal text; [0, 1, 0, 0] denotes politically reactionary text; [0, 0, 1, 0] denotes pornographic text; and [0, 0, 0, 1] denotes the text of another type.)

Text vector: [1, 1, 1, 1, 0] (The first number 1 represents that "illegal" in the dictionary occurs once in the text; the second number 1 represents that "politically" in the dictionary occurs once in the text; and other numbers can also be explained in this manner.)

### Model Training

The tagged text vector is input into a recurrent neural network to train the recurrent neural network. Then the trained model is output.

### Model Application

After the model training is completed, illegal content is detected based on steps in FIG. 5. Finally, the text is scored for classification. A category with a relatively high score is taken as the text category.

For example, {'probe_dist': {

'sexy':0, 'legal':0.3, 'political':0.6, 'other_illegal':0.1 } }

Based on the score in the preceding scoring result, the article is determined as a politics-related article.

### Embodiment Three

### I. Test on Detection of Sensitive Words

1. Test text

| | | |
|---|---|---|
| Count of Test Text | Content | Remarks |
| 3944 articles | current politics, sports, entertainment and other news | Crawl network news |

### 2. Test on a Sensitive-Word Dictionary

["Taiwan independence": "politically sensitive",

"Democratic Progressive Party": "politically sensitive",

"Kuomintang": "politically sensitive"]

3. Test results

| Count of Text Containing a Sensitive Word in a Test Set | Count of Text Identified through Detection | Identification Accuracy Rate |
|---|---|---|
| 197 | 197 | 100% |

### 4. Result Description

Sensitive words contained in the text can be identified accurately through the function of detection of sensitive words. Based on the identified sensitive words, the articles are determined politically sensitive articles. Sensitive words in other categories can also be identified accurately and the corresponding categories are determined.

### II. Test on Identification and Classification of Illegal Content

### 1. Model Creation

In the method of the present application, for detection of sensitive words, no model needs to be created, and only programming is required. For identification and classification of illegal content, a model may be created. The data used for creating the model are as below.

| Data Type | Normal Text | Political Reaction | Pornography | Others |
|---|---|---|---|---|
| Count (article) | 67265 | 25971 | 2886 | 11549 |

### 2. Test

2.1. Test text

| Data Type | Count | Remarks |
|---|---|---|
| Normal Text | 11826 | Normal text may cover as many fields as possible, for example, science and technology, sports, news, entertainment, politics, and finance and economics. Articles that include political, pornographic, and gambling sensitive words and are legal are also covered. |
| Political Reaction | 3081 | Political news and theses do not belong to political reaction. |
| Pornography | 1000 | Articles for science popularization and articles in the medical field do not belong to pornography. |
| Gambling | 1443 | Articles related to lotteries, stocks, and finance and economics do not belong to gambling. |

2.2. Test results

| Model | Accuracy rate | Precision rate | Recall rate | F1 value |
|---|---|---|---|---|
| Classification model | 0.9852 | 0.9803 | 0.9984 | 0.992 |

### 2.3 Description

The accuracy rate, the precision rate, the recall rate, and the definition of the F1 value are described below.

Reference is made to a confusion matrix before each indicator is introduced. If a problem of binary classification exists, four situations occur when predicted results and actual results are combined in pairs.

| | | Actual Results | |
|---|---|---|---|
| | | 1 | 0 |
| Predicted Results | 1 | 11 | 10 |
| | 0 | 01 | 00 |

Since the representation by numbers 1 and 0 does not facilitate reading, T (True) denotes correctness, F (False) denotes incorrectness, P (Positive) denotes 1, and N (Negative) denotes 0. A predicted result (P|N) is viewed first; and then a determination result is given based on the comparison of a predicted result and an actual result. Based on the preceding logic, the table below is obtained after redistribution.

| | | Actual Results | |
|---|---|---|---|
| | | 1 | 0 |
| Predicted Results | 1 | TP | FP |
| | 0 | FN | TN |

TP, FP, FN, and TN may be understood as below.
TP: indicates that the predicted result is 1; the actual result is 1; and the prediction is correct.
FP: indicates that the predicted result is 1; the actual result is 0; and the prediction is incorrect.
FN: indicates that the predicted result is 0; the actual result is 1; and the prediction is incorrect.
TN: indicates that the predicted result is 0; the actual result is 0; and the prediction is correct.

The accuracy rate is the percentage of the correctly predicted results in total samples. The expression of the accuracy rate is as below.

$$\text{Accuracy rate =} \frac{\text{TP} \text{+} \text{TN}}{\text{TP} \text{+} \text{TN} \text{+} \text{FP} \text{+} \text{FN}}$$

The precision rate, in terms of the predicted results, refers to the probability that a sample among all the samples predicted to be positive is actually positive. The expression of the precision rate is as below.

$$\text{Precision rate =} \frac{\text{TP}}{\text{TP + FP}}$$

The recall rate, in terms of original samples, refers to the probability that a sample among all the actually positive samples is predicted to be positive. The expression of the recall rate is as below.

$$\text{Recall rate =} \frac{\text{TP}}{\text{TP + FN}}$$

The expression of the F1 score is as below.

$$\text{F1 score =} \frac{\text{2} \times \text{Precision rate} \times \text{Recall rate}}{\text{Precision rate + Recall rate}}$$

FIG. 6 is a diagram illustrating the structure of hardware of an electronic device according to an embodiment. As shown in FIG. 6, the electronic device includes one or more processors 110 and a memory 120. FIG. 6 illustrates an example of one processor 110.

The electronic device may further include an input apparatus 130 and an output apparatus 140.

The processor 110, the memory 120, the input apparatus 130, and the output apparatus 440 that are in the electronic device may be connected through a bus or in other manners. FIG. 6 illustrates an example of the connection through a bus.

As a computer-readable storage medium, the memory 120 may be configured to store software programs, computer-executable programs, and modules. The processor 110 runs the software programs, instructions and modules stored in the memory 120 to perform function applications and data processing, that is, to implement any method in the preceding embodiments.

The memory 120 may include a program storage region and a data storage region. The program storage region may store an operating system and an application program required by at least one function. The data storage region may store the data created according to the use of the electronic device. Additionally, the memory may include a volatile memory, for example, a random access memory (RAM), and may also include a non-volatile memory, for example, at least one magnetic disk memory element, a flash memory element, or another non-volatile solid-state memory element.

The memory 120 may be a non-transient computer storage medium or a transient computer storage medium. The non-transitory computer storage medium includes, for example, at least a magnetic disk memory element, a flash memory element, or another non-volatile solid-state memory element. In some embodiments, the memory 120 optionally includes memories which are disposed remotely relative to the processor 110. These remote memories may be connected to the electronic device via a network. The examples of the preceding network may include the Internet, an intranet, a local area network, a mobile communication network, and a combination thereof.

The input apparatus 130 may be configured to receive the input digital or character information and generate key signal input related to user settings and function control of the electronic device. The output apparatus 140 may include a display device, for example, a display screen.

This embodiment further provides a computer-readable storage medium storing computer-executable instructions for executing the preceding methods.

All or part of the procedure processes in a method of the preceding embodiments may be performed by related hardware executed by computer programs. The programs may be stored in a non-transitory computer-readable storage medium. During the execution of the programs, the processes in a method according to the preceding embodiments may be included. The non-transitory computer-readable storage medium may be, for example, a magnetic disk, an optical disk, a read-only memory (ROM), or an RAM.

Compared with the related technology, the present application has the advantages below.
1. The accuracy rate is high. The present application combines detection of sensitive words and identification of illegal content, smoothing the absoluteness of detection and classification of sensitive words, enhancing the probability of using identification of illegal content, and improving the accuracy rate of classification.
2. The efficiency is high. The present application first classifies a text through detection of sensitive words and then determines whether identification of illegal content needs to be performed, enhancing the efficiency of the text classification process.
3. The expansibility is strong. In the present application, the sensitive-word dictionary may be created by customization; alternatively, a built-in dictionary may be used as the sensitive-word dictionary. Accordingly, the expansibility of the present application is enhanced.

1. A text classification method, comprising:
step 1: acquiring to-be-tested text and performing steps 2 and 3 simultaneously;
step 2: detecting a sensitive word through an Aho-Corasick (AC) automaton and performing step 4;
step 3: identifying illegal content through a recurrent neural network model and performing step 6;
step 4: determining whether the to-be-tested text contains the sensitive word; and performing step 5 in response to a determination result that the to-be-tested text contains the sensitive word, or returning to step 3 in response to a determination result that the to-be-tested text does not contain the sensitive word;
step 5: in response to the to-be-tested text containing the sensitive word, determining a text category based on the sensitive word and performing step 9;
step 6: determining whether the to-be-tested text contains the illegal content; and performing step 7 in response to a determination result that the to-be-tested text contains the illegal content, or performing step 8 in response to a determination result that the to-be-tested text does not contain the illegal content;
step 7: in response to the to-be-tested text containing the illegal content, determining the text category based on the illegal content and performing step 9;
step 8: in response to the to-be-tested text not containing the illegal content, performing step 9; and
step 9: ending a current round of processing logic.

2. The text classification method according to claim 1, wherein the step 2 comprises: step 2-1: creating a trie based on a sensitive-word dictionary; and
step 2-2: adding a fail pointer to the trie.

3. The text classification method according to claim 1, wherein the step 3 comprises: step 3-1: performing preprocessing on the to-be-tested text; and
step 3-2: detecting the illegal content through a trained recurrent neural network model.

4. The text classification method according to claim 3, wherein the preprocessing in the step 3-1 is word segmentation processing of the to-be-tested text.

5. The text classification method according to claim 3, wherein the recurrent neural network model in step 3-2 is trained through:
step 3-2-1: performing a vectorization operation on tagged training text based on an illegal lexicon; and
step 3-2-2: inputting a tagged text vector into a recurrent neural network to train, and outputting the trained recurrent neural network model.

6. The text classification method according to claim 5, wherein the text vector in the step 3-2-2 is a word frequency vector of a word belonging to the illegal lexicon and contained in the training text.

7. The text classification method according to claim 1, wherein the step 5 comprises determining, based on a sensitive-word dictionary, a sensitive word category to which the sensitive word belongs.

8. The text classification method according to claim 1, wherein the step 7 comprises scoring the to-be-tested text through a recurrent neural network, wherein a category with a score exceeding a set value is the text category.

9. A text classification method, comprising:
acquiring a to-be-tested text;
detecting a sensitive word through an Aho-Corasick (AC) automaton to determine whether the to-be-tested text contains the sensitive word; and
in response to a determination result that the to-be-tested text contains the sensitive word, determining a text category of the to-be-tested text based on the sensitive word contained in the to-be-tested text.

10. The text classification method according to claim 9, after detecting the sensitive word through the AC automaton to determine whether the to-be-tested text contains the sensitive word, the method further comprising:
in response to a determination result that the to-be-tested text does not contain the sensitive word, identifying illegal content through a recurrent neural network model to determine whether the to-be-tested text contains the illegal content; and
in response to a determination result that the to-be-tested text contains the illegal content, determining the text category of the to-be-tested text based on the illegal content contained in the to-be-tested text.

11. An electronic device, comprising:
a processor; and
a memory configured to store a program, wherein
when the program is executed by the processor, the processor implements steps:
step 1: acquiring to-be-tested text and performing steps 2 and 3 simultaneously;
step 2: detecting a sensitive word through an Aho-Corasick (AC) automaton and performing step 4;
step 3: identifying illegal content through a recurrent neural network model and performing step 6;
step 4: determining whether the to-be-tested text contains the sensitive word; and performing step 5 in response to a determination result that the to-be-tested text contains the sensitive word, or returning to step 3 in response to a determination result that the to-be-tested text does not contain the sensitive word;
step 5: in response to the to-be-tested text containing the sensitive word, determining a text category based on the sensitive word and performing step 9;
step 6: determining whether the to-be-tested text contains the illegal content; and performing step 7 in response to a determination result that the to-be-tested text contains the illegal content, or performing step 8 in response to a determination result that the to-be-tested text does not contain the illegal content;
step 7: in response to the to-be-tested text containing the illegal content, determining the text category based on the illegal content and performing step 9;
step 8: in response to the to-be-tested text not containing the illegal content, performing step 9; and
step 9: ending a current round of processing logic.

12. A non-transitorycomputer-readable storage medium storing computer-executable instructions for executing the text classification method according to claim 1.

13. The electronic device according to claim 11, wherein the step 2 comprises:
step 2-1: creating a trie based on a sensitive-word dictionary; and
step 2-2: adding a fail pointer to the trie.

14. The electronic device according to claim 11, wherein the step 3 comprises:
step 3-1: performing preprocessing on the to-be-tested text; and
step 3-2: detecting the illegal content through a trained recurrent neural network model.

15. The electronic device according to claim 14, wherein the preprocessing in the step 3-1 is word segmentation processing of the to-be-tested text.

16. The electronic device according to claim 14, wherein the recurrent neural network model in step 3-2 is trained through:
step 3-2-1: performing a vectorization operation on tagged training text based on an illegal lexicon; and
step 3-2-2: inputting a tagged text vector into a recurrent neural network to train, and outputting the trained recurrent neural network model.

17. The electronic device according to claim 16, wherein the text vector in the step 3-2-2 is a word frequency vector of a word belonging to the illegal lexicon and contained in the training text.

18. The electronic device according to claim 11, wherein the step 5 comprises determining, based on a sensitive-word dictionary, a sensitive word category to which the sensitive word belongs.

19. The electronic device according to claim 11, wherein the step 7 comprises scoring the to-be-tested text through a recurrent neural network, wherein a category with a score exceeding a set value is the text category.
